(19) United States
(12) Patent Application Publication
(10) Pub. No.: US 2025/0369248 A1
(43) Pub. Date: Dec. 4, 2025

(54) Earthquake Safety Protection Device

(71) Applicant: Timothy Grigsby, Atlanta, GA (US)

(72) Inventor: Timothy Grigsby, Atlanta, GA (US)

(21) Appl. No.: 19/262,767

(22) Filed: Jul. 8, 2025

Related U.S. Application Data
(63) Continuation of application No. 17/942,363, filed on Sep. 12, 2022, now Pat. No. 12,378,791.
Application No. 17/942,363 is a continuation-in-part of application No. 17/529,062, filed on Nov. 17, 2021, now abandoned.
Application No. 17/529,062 is a continuation-in-part of application No. 17/391,590, filed on Aug. 2, 2021, now abandoned.
Application No. 17/391,590 is a continuation-in-part of application No. 17/344,017, filed on Jun. 10, 2021, now abandoned.
(60) Provisional application No. 63/040,284, filed on Jun. 17, 2020.

(51) Int. Cl. E04H 9/02; E06B 1/04; E06B 1/12

(52) U.S. Cl. CPC E04H 9/027; E04H 9/021; E04H 9/024; E04H 9/029; E06B 1/04; E06B 1/12

(57) ABSTRACT

An article of manufacture for an earthquake safety protection device (ESPD) according to the present invention is disclosed. The ESPD consists of an earthquake support pole and mating support members to create survivable space around the support pole should a room be damaged in an earthquake. The ESPD may also comprise a reinforced frame within an interior door of a building. The reinforced frame resists damage from an earthquake that may prevent the interior door from opening. Opening or removal of the inner door protected by the reinforced frame creates a means of safely exiting a room in spite of damage to the interior door and its corresponding door frame. The ESPD may also include a mechanism to prevent a mobile hospital bed from moving about a room during an earthquake.

### CROSS-REFERENCE TO RELATED APPLICATION

This application claims priority to U.S. patent application Ser. No. 17/942,363, titled “Earthquake Safety Protection Device,” and filed on Sep. 12, 2022, now U.S. Pat. No. 12,???,??? issued ?? Aug.-Sep. 2025, which a continuation of U.S. patent application Ser. No. 17/529,062, titled “Earthquake Safety Protection Device,” and filed on Nov. 17, 2021, which itself claims priority to U.S. patent application Ser. No. 17/391,590, titled “Earthquake Safety Protection Device,” and filed on Aug. 2, 2021, which itself claims the benefit of the U.S. patent application Ser. No. 17/344,017, titled “Earthquake Safety Protection Device,” and filed on Jun. 10, 2021, which itself claims the benefit of the U.S. Provisional Patent Application No. 63/040,284, titled “Earthquake Safety Protection Device,” and filed on Jun. 17, 2020. This application is also concurrently being filed with U.S. patent application Ser. No. 19/???,???, titled “Earthquake Safety Protection Device,” and filed on Jul. ??, 2025. These entire applications are incorporated herein by reference in its entirety.

### TECHNICAL FIELD

This application relates in general to an article of manufacture for providing an earthquake safety protection device.

### BACKGROUND

People may become trapped within a damaged building following an earthquake. Depending upon the severity of the earthquake, significant damage may occur to a building in the earthquake zone that may result in walls and ceilings collapsing and trapping victims within the building. The damaged walls and ceilings typically fall onto individuals causing injuries. Damage to the walls and ceilings may also prevent inner doors from opening creating further obstacles to a safe escape from a damaged building.

The present invention attempts to address existing building designs according to the principles and example embodiments disclosed herein. The earthquake safety protection device attempts to create survivable space within a building that preserves areas in which people may remain unharmed from falling debris. The present invention also attempts to allow victims of an earthquake to safely exit a building with damage to interior doors that prevents the doors from opening.

### SUMMARY

In accordance with the present invention, the above and other problems are solved by providing an article of manufacture for an earthquake safety protection device (ESPD) according to the present invention. The earthquake safety protection device includes an earthquake support pole having a top end positioned about the habitable ceiling of a space and a bottom end, a plurality of support members coupled to the top end of the earthquake support poles, the plurality of support members being perpendicular to the earthquake support pole and being adjacent to the ceiling, and an anchoring mechanism coupling the bottom end of the earthquake support pole to the floor, the anchoring mechanism includes an in-ground anchor coupled to the one or more earthquake support poles, the in-ground anchor comprises a plurality of anchor arms radiating out from a center location. Each of the plurality of anchor arms include a plurality of energy absorbing cross-members, all of which are within a central layer.

In another aspect of the present invention, the plurality of support members each have a pair of ends and a center point, and the plurality of support members are coupled to the earthquake support pole about the center point.

In another aspect of the present invention, the plurality of support members each have a pair of ends and a center point, and the plurality of support members are coupled to the earthquake support pole about the one of the ends of each support member.

In another aspect of the present invention, the earthquake support pole is positioned within a corner of the habitable space,

In another aspect of the present invention, the earthquake support pole further comprises a handle.

In another aspect of the present invention, the earthquake support pole is positioned about a center of the habitable space.

In another aspect of the present invention, the earthquake support pole is further coupled to a steel table having legs in contact with the floor of the habitable space.

In another aspect of the present invention, the earthquake support pole further energy absorbing material between the earthquake support pole and the building foundation and anchoring material.

In another aspect of the present invention, the energy absorbing material comprises a compressible material configured to dissipate the energy of the movement of the earthquake support pole relative to the building foundation and anchoring material.

In another aspect of the present invention, he earthquake support pole further energy absorbing material between the earthquake support pole and the building foundation and anchoring material and between the earthquake support pole and the corner of the building in which the earthquake support pole is installed.

In another aspect of the present invention, the multiple earthquake support poles are positioned at different locations within the building.

In another aspect of the present invention, the multiple earthquake support poles are located on a plurality of floors of the building.

In another aspect of the present invention, the multiple earthquake support poles on upper floors of the building are anchored into structural elements within the building.

In another aspect of the present invention, the structural elements comprise steel beams within the building.

In another aspect of the present invention, the one or more earthquake support poles being located outside of buildings about outside walls.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIGS. 1a-b illustrate one potential embodiment of an article of manufacture for an earthquake safety protection device (ESPD) according to the present invention.

FIGS. 2a-b illustrate another potential embodiment of an article of manufacture for an ESPD according to the present invention.

FIG. 3 illustrates a potential embodiment of an in-ground anchor 300 used in an article of manufacture for an ESPD according to the present invention

FIG. 4 illustrates yet another potential embodiment of an article of manufacture for an ESPD according to the present invention.

FIG. 5 illustrates another potential embodiment of multiple articles of manufacture for an ESPD in a building according to the present invention.

FIGS. 6a-c illustrate another potential embodiment of an article of manufacture for an ESPD in multiple floors of a building according to the present invention.

FIG. 7 illustrates another potential embodiment of multiple articles of manufacture for an ESPD outside of buildings according to the present invention.

### DETAILED DESCRIPTION

This application relates in general to an article of manufacture for an earthquake safety protection device (ESPD).

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components but do not preclude the presence or addition of one or more other features, steps, or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes and other quantities and characteristics are not and need not be exact but may be approximated and/or larger or smaller, as desired, reflecting tolerances, conversion factors, rounding off, measurement error and the like and other factors known to those of skill. Further, unless otherwise stated, the term “about” shall expressly include “exactly.”

The terms “user” and “victim” refer to an entity, e.g., a human, who is protected by an earthquake safety protection device (ESPD) according to the present invention. In a particular case, the user is one that is located within a building or other built space during an earthquake. For such a user, the terms user and victim may be used herein interchangeably.

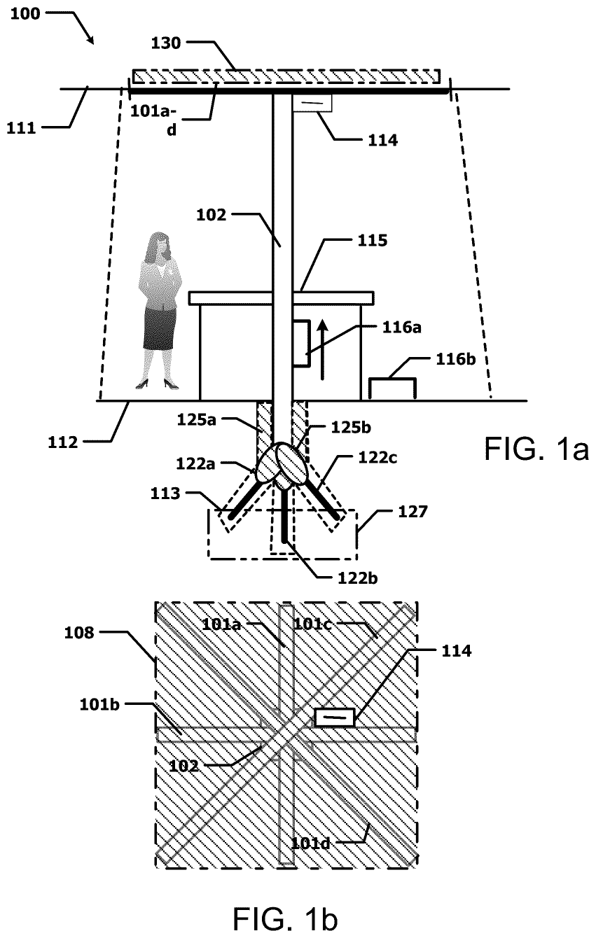

FIGS. 1a-b illustrate one potential embodiment of an article of manufacture for an earthquake safety protection device (ESPD) according to the present invention. FIG. 1a shows a front view of a living or working space in a building that uses the ESPD according to the present invention. An earthquake support pole 102 is placed between a floor 112 and a ceiling structure 111 to create survivable space 100 within a building. The earthquake support pole 102 is coupled to a plurality of support members 101a-d at the top end of the support pole. These plurality of support members 101a-d are also coupled to the ceiling structure 111.

The earthquake support pole 102 typically has dimensions that are long enough to run from a ceiling structure 111 to the floor 112. In some embodiments, the earthquake support pole 102 may be placed within a properly sized enclosure 113 of the floor 112 that possesses a horizontal anchoring member 121 and a plurality of diagonal anchoring members 122a-b with an entire anchoring mechanism being encased in concrete to provide additional support to the pole. The plurality of support members 101a-d may be coupled to the pole mechanically using fasteners such as nuts and bolts, a weld if the plurality of support members 101a-d and the earthquake support pole 102 are made of weldable metal, and other coupling techniques such as forging the pole and support members into a single structure. The plurality of support members 101a-d and the earthquake support pole 102 may be made of steel or other metals, wood, or other synthetic materials that provide sufficient strength to maintain space around the support pole when an earthquake has caused damage to the building. A toolbox 114 containing a miscellaneous tool kit, gloves, flashlight, etc. to aid individuals who may be in this area during an earthquake. The toolbox 114 is typically located near the earthquake support pole 102 near the ceiling to keep it out of the way while remaining accessible when needed.

In one embodiment, the earthquake support pole 102 may also provide an attached steel desk or tabletop 115 that may be coupled to the earthquake support pole 102. The tabletop 115 may also be positioned in other locations under the plurality of support members 101a-d. The steel desk 115 may provide additional protected space underneath its top surface for people to retreat to find additional protection from falling debris.

Additionally, the earthquake support pole 102 engages a foundation of a building and anchoring material when the earthquake support pole 102 is anchored through the floor 112 of a building and into the ground. The entire anchoring mechanism 113 consisting of a plurality of diagonal anchoring members 122a-b is typically embedded within anchoring material such as concrete, the earth below the building, and other parts of the foundation of the building into which the earthquake support pole 102 is installed.

In some embodiments, an energy absorbing material 125a-b may be placed between the earthquake support pole 102 and the building as well as between the entire anchoring mechanism 113 and the earth. When an earthquake moved the earth under the building and floor 112, this motion is translated to the building foundation as well as earthquake support pole 102 and the entire anchoring mechanism 113. By placing the energy absorbing material 125a-b between the earth and the earthquake support pole 102 and anchoring mechanism 113, the movement of the ground compresses the energy absorbing material 125a-b to reduce the force of the earthquake on the building, the building foundation, and the earthquake support pole 102 and anchoring mechanism 113.

Lastly, in some embodiments, one or more handles 116a-b may be attached to the earthquake support pole 102 to provide individuals utilizing the survivable space 100 an item to grasp during an earthquake until the tremor ends. These handles 116a-b may be located at fixed locations along the earthquake support pole 102 and floor, may pop out of the earthquake support pole 102 at various heights along the earthquake support pole 102, or may pop up from the floor to a useful height for the occupants of the survivable space 100. For the handles 116a-b that may pop out from a storage position, the handles may include an automatic locking mechanism to hold them in place once out of storage locations to provide users with sturdy and secure handles to hold.

FIG. 1b shows a top view of the plurality of support members 101a-d and the earthquake support pole 102. The plurality of support members 101a-d are arranged in a crisscross pattern and are centered about the earthquake support pole 102. This arrangement allows the plurality of support members 101a-d to create survivable space 100 around the earthquake support pole 102 should the building suffer damages. In some embodiments, a horizontal layer 108 may be coupled between the ceiling structure 111 and the plurality of support members 101a-d to help prevent debris from falling within the survivable space around the earthquake support pole 102. The horizontal layer 108 may be made of metal or wood and may be coupled to the plurality of support members 101a-d in a manner similar to how the earthquake support pole 102 is coupled to the support members.

In some alternate embodiments, the space under the earthquake support pole 100 may also include a solid sheet of material 130 as part of each of the plurality of earthquake support poles 100. The sheet of material may be made of steel, aluminum, copper, tin, and other solid materials that will sustain impact from falling material without breeching. This sheet of material 130 will provide a barrier between the building material and the space about the earthquake support pole 100 to further protect individuals in this space from falling debris.

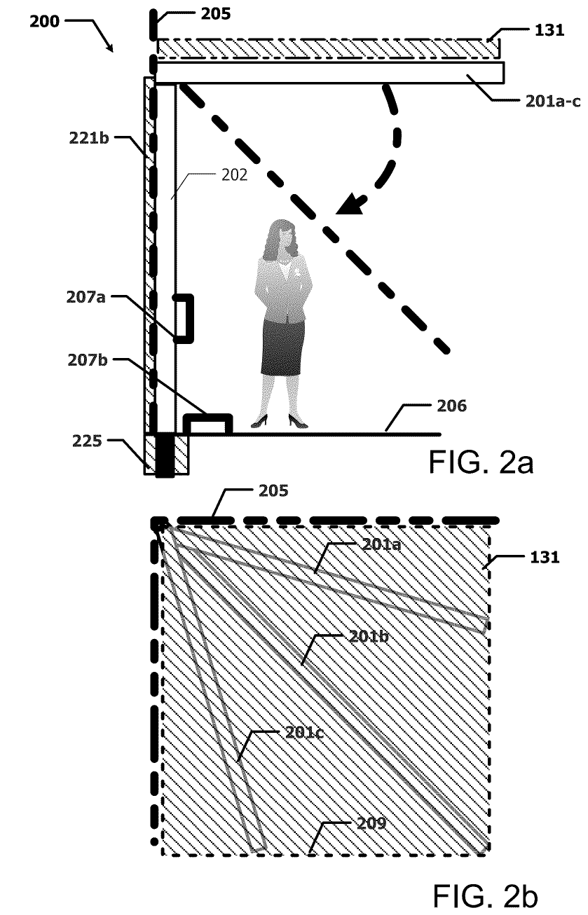

FIGS. 2a-b illustrate another potential embodiment of an article of manufacture for providing an earthquake safety protection device in a corner of space within a building according to the present invention. FIG. 2a shows a side view of a living or working space in a building that uses the earthquake safety protection device (ESPD) according to the present invention. A pair of walls 205 form a corner of a room or other space in a building in which a corner support pole 202 is located. The corner support pole 205 may be coupled to the wall and any underlying wall structures while running from the floor 206 to the corner ceiling structure 208. A plurality of corner support members 201a-c are coupled to the top of the corner support pole 202 and extend outward from the corner into the living area to create survivable space 200 underneath. The corner support pole 202 may include a victim support grip 207 that acts as a handle to support someone during an earthquake.

The corner support pole 202 typically has is long enough to run from a ceiling structure 208 to the floor 206. The plurality of corner support members 201a-d may be coupled to the pole mechanically using fasteners such as nuts and bolts, a weld if the plurality of corner support members 201a-c and the corner support pole 202 are made of weldable metal, and other coupling techniques such as forging the pole and support members into a single structure. The plurality of corner support members 201a-c and the corner support pole 202 may be made of steel or other metals, wood, or other synthetic materials that provide sufficient strength to maintain space around the support pole when an earthquake has caused damage to the building.

The corner support pole 202 is anchored into the floor, building and anchoring material below the building in a manner disclosed above in reference to FIG 1a. The corner support pole 202 is also coupled to the building at the corner of a room or space within the building. As with the earthquake support pole 102, energy absorbing material 221a may be placed about the corner support pole 102 as disclosed above with reference to FIG. 1a. Additionally, energy absorbing material 221b may be placed between the corner support pole 202 and the corner of the space or room to again be compressed by any movement of the corner support pole 202 relative to the corner of the building to attempt to reduce the movement of the earth from being directed into the corner support pole 202 and its connection members.

FIG. 2b shows a top view of the plurality of corner support members 201a-c and the corner support pole 202. The plurality of corner support members 101a-d are arranged in a fan-like pattern and are centered about the corner support pole 202. The arrangement of the plurality of corner support members 201a-c creates survivable space 200 around the corner support pole 202 should the building suffer damages. In some embodiments, a horizontal layer 209 may be coupled between the ceiling structure 208 and the plurality of corner support members 201a-c to provide additional material to prevent debris from falling within the survivable space around the corner support pole 202. The horizontal layer 209 may be made of metal or wood and may be coupled to the plurality of corner support members 201a-c in a manner similar to how the corner support pole 202 is coupled to the support members.

In some alternate embodiments, the space under the earthquake support pole 200 may also include a solid sheet of material 131 as part of the earthquake support pole 200 as described above in reference to FIG. 1. These sheet of material 131 will provide a barrier between the building material and the space about the earthquake support pole 200 to further protect individuals in this space from falling debris.

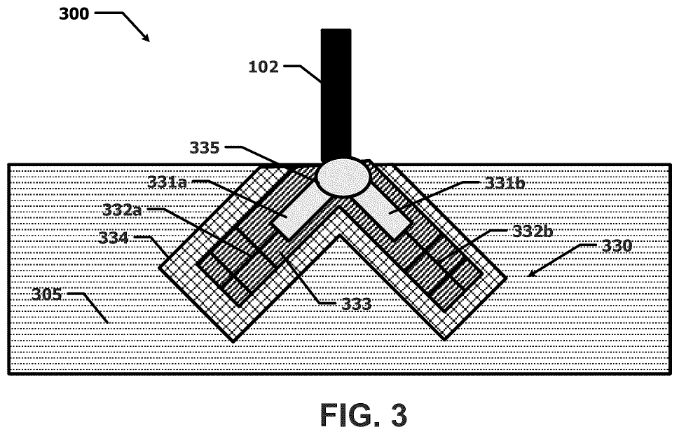

FIG. 3 illustrates a potential embodiment of an in-ground anchor 300 used in an article of manufacture for an ESPD according to the present invention. This in-ground anchor 300 may be utilized with the ESPD disclosed herein in reference to FIGS. 1-2 while having a more complex anchor structure 310c in the ground. The complex anchor structure 330 comprises a plurality of anchor arms 331a-b radiating out from a center location 335, each of which has a plurality of energy absorbing cross-members 332a-b, all of which are within a central layer 333. The energy absorbing cross-members 332a-b works with along with the central layer 333 to dissipate the shaking energy of the building 330. The central layer 333 may be an air filled cavity or alternatively a cavity filled with a thick material having a semi-fluid consistency to slow down the motion of the energy absorbing cross-members 332a-b. The entire complex anchor structure 330 may be encased within concrete 334 to form the base of the structure. Alternate example embodiments for in-ground anchors are disclosed in detail in the commonly owned and currently pending related U.S. patent applications referenced above.

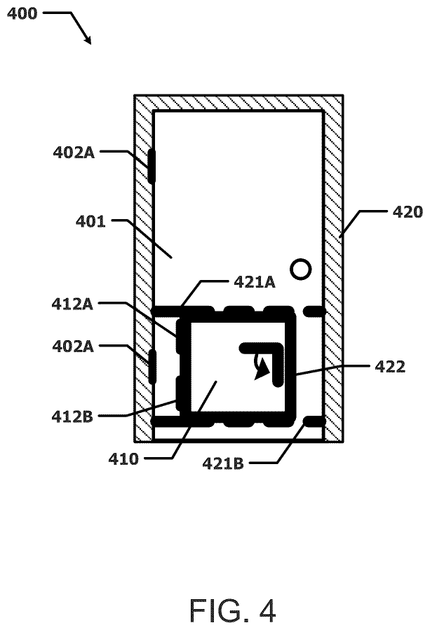

FIG. 4 illustrates yet another potential embodiment of an article of manufacture for an earthquake safety protection device (ESPD) according to the present invention. In this embodiment, an earthquake escape structure 400 is constructed within an interior door within a building. The earthquake escape structure 400 comprises an inner egress door 410 located within a reinforced inner frame 420. The reinforced inner frame 420 may be constructed of metal or wood and has a thickness to increase the likelihood that the frame will remain intact even when the interior egress door 410 and the reinforced frame 420 forming a door jamb and/or hinges 402a-b are damaged in an earthquake.

Should the space within the building around the door 401 be damaged, the interior egress door may not safely open. If victims are located within living space behind the damaged interior egress door, these victims may be trapped in the building until they can be rescued. When the interior egress door 410 contains an earthquake escape structure 400, individuals may open the inner egress door 410 and pass through the inner reinforced frame 420. The inner egress door 410 may be coupled to the reinforced inner frame 303 using hinges 412a-b and accessed by rotating a locking handle 411 within the inner door 410. In alternate embodiments, the inner door 410 may be secured within coupling tabs in place of hinges that permit the entire inner door 410 to be removed from the reinforced frame 420 once the locking handle 411 is disengaged.

The interior egress door 401 may also be enclosed in a solid steel reinforced frame 422 coupled between one or more cross members 421a-b in order to reinforce the space containing the door 401 as well as the inner door 410 and its inner reinforced frame 421a-b. The inner reinforced frame may be coupled to the reinforced frame 420 when the interior egress door 401 is closed by the one or more cross members 421a-b.

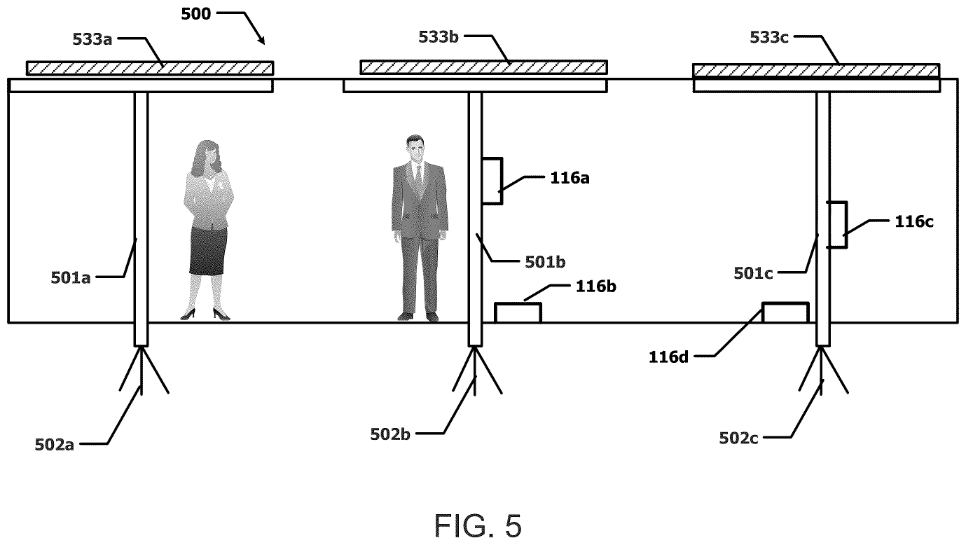

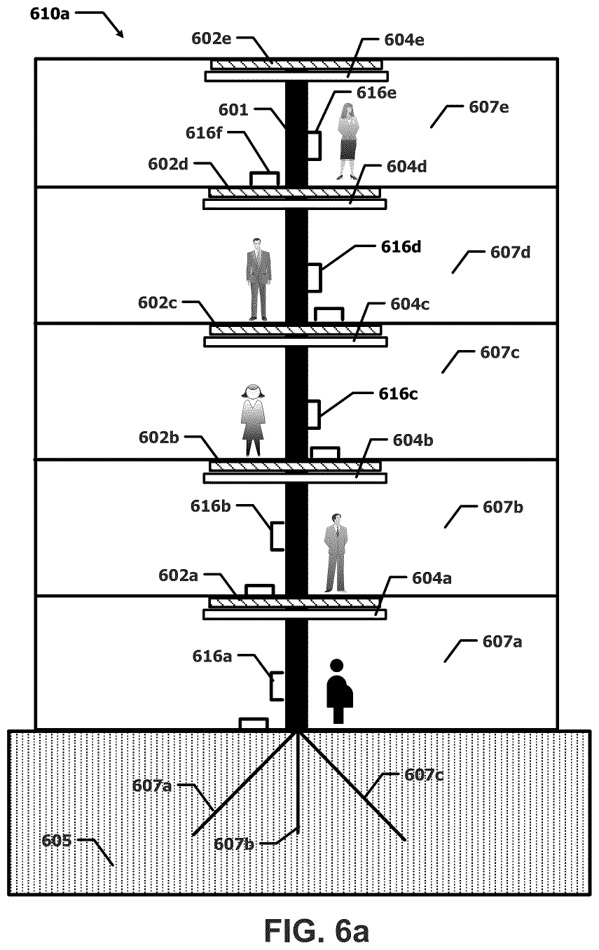

FIG. 5 illustrates another potential embodiment of multiple articles of manufacture for an ESPD in a building according to the present invention. A plurality of earthquake support pole 501a-c may be installed in buildings having large open spaces 500. Examples of these open spaces may include a stadium and concourse, a factory and warehouse, a gymnasium, and auditorium and theater. The plurality of earthquake support pole 501a-c may be spaced about the large open space 500 to create sufficient number of survivable spaces within the large open space 500 to protect an expected number of occupants of the space from damage to the building caused by an earthquake.

In some alternate embodiments, the space under the plurality of earthquake support poles 501a-c may also include a solid sheet of material 533a-c as part of each of the plurality of earthquake support poles 501a-c as described above in reference to FIGS. 1-2. These sheets of material 533a-c will provide a barrier between the building material and the space about the plurality of earthquake support poles 501a-c to further protect individuals in this space from falling debris.

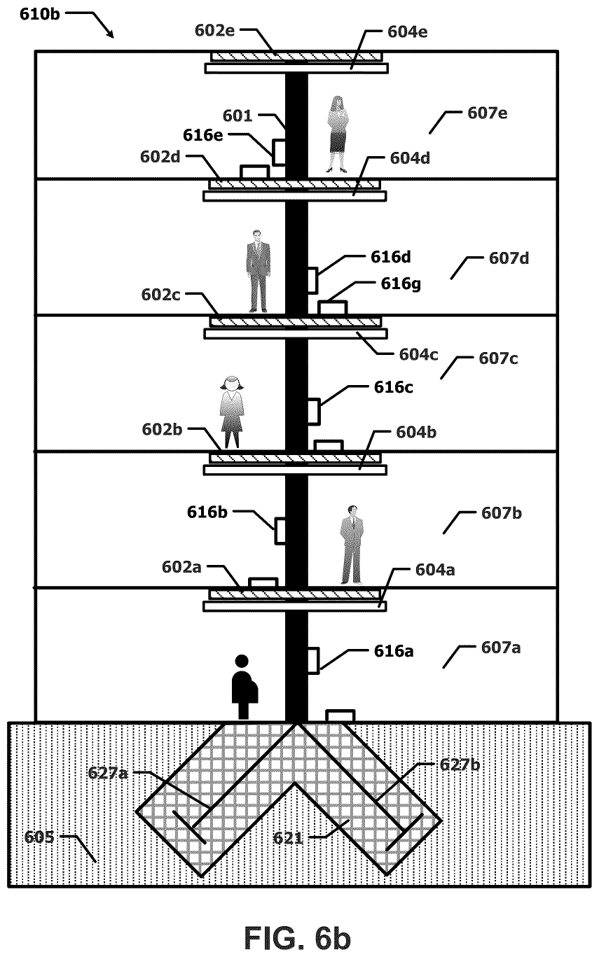

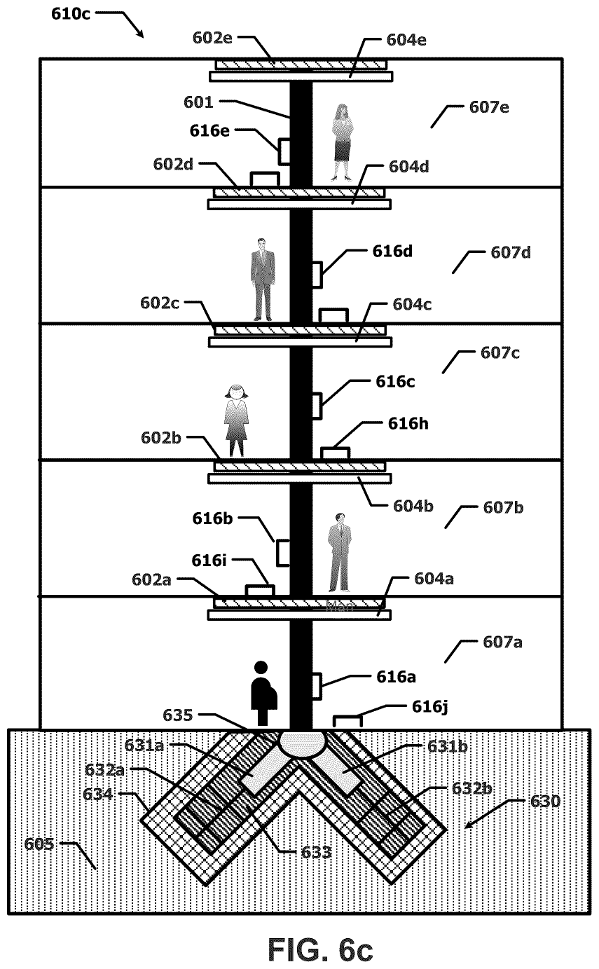

FIG. 6a illustrates another potential embodiment of an article of manufacture for an ESPD in multiple floors of a building according to the present invention. The earthquake support member 601 may be installed on multiple floors 609a-e of building 610a. In a preferred embodiment, a vertical earthquake support member 601 is anchored into the ground 605 by a plurality of anchor members 607a-c. The vertical earthquake support member 601 may run through an entire building 610a in which a survivable space 100 may be created about the vertical earthquake support member 601. Each floor may also include a horizontal supports 604a-e coupled to the vertical earthquake support member 601 with a solid sheet of material 602a-e on top to create space in the manner disclosed above with respect to FIG. 1-5. Handles 616a-j may be included within the earthquake support member as disclosed above in reference to FIG. 1.

FIG. 6b shows a second embodiment of the multi-floor building 610b having all of the above ground protection items as described in reference to FIG. 6a. In this embodiment, anchor members 627a-b may be encased within concrete 621 when installed into the ground 605. While the example of FIG. 6b shows 2 anchors 627a-b, one skilled in the art will recognize that additional anchors may be used will all anchors being present being coupled to the earthquake support member at a center location. Handles 616a-j may be included within the earthquake support member as disclosed above in reference to FIG. 1.

FIG. 6c shows a third embodiment including all of the above ground items as disclosed above in reference to FIGS. 6a-b while having a more complex anchor structure 610c in the ground. The complex anchor structure 630 comprises a plurality of anchor arms 631a-b radiating out from a center location 635, each of which has a plurality of energy absorbing cross-members 632a-b, all of which are within a central layer 633. The energy absorbing cross-members 632a-b works with along with the central layer 633 to dissipate the shaking energy of the building 630. The central layer 633 may be an air filled cavity or alternatively a cavity filled with a thick material having a semi-fluid consistency to slow down the motion of the energy absorbing cross-members 632a-b. The entire complex anchor structure 630 may be encased within concrete 634 to form the base of the structure. Handles 616a-j may be included within the earthquake support member as disclosed above in reference to FIG. 1.

Examples of these floors 609a-e may be found in many office and retail building 610, 620, 630, especially is towns and cities. The vertical earthquake support pole 601 may be spaced about each of the floors 609a-e to create sufficient number of survivable spaces within the building 600 to protect an expected number of occupants of the space from damage to the building caused by an earthquake.

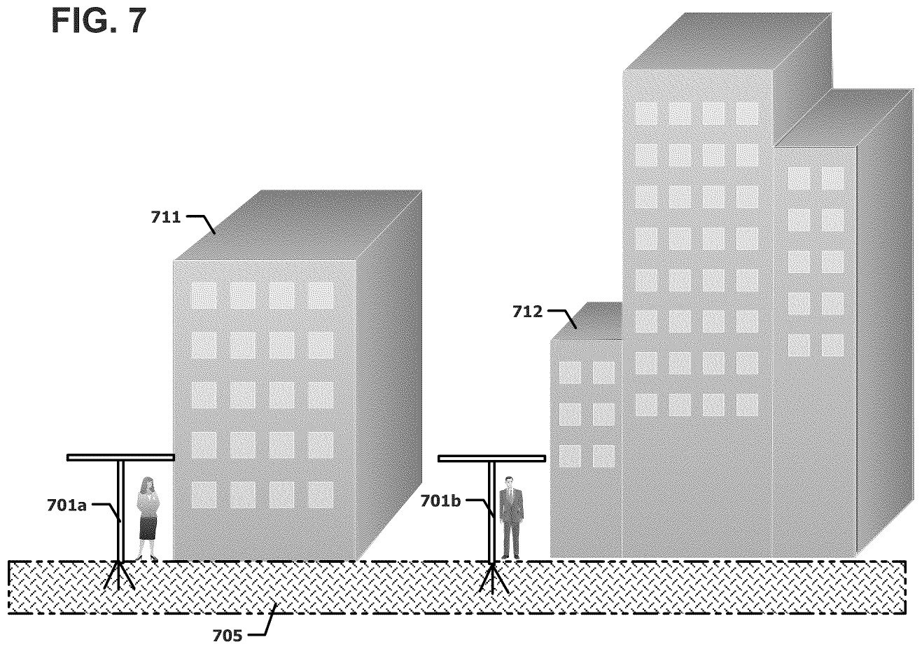

FIG. 7 illustrates another potential embodiment of multiple articles of manufacture for an ESPD outside of buildings according to the present invention. In this embodiment, one or more earthquake support poles 701a-b are positioned about buildings 710-711. The earthquake support poles 710a-b are near about the buildings 711-712 that may provide protection to individuals standing under the earthquake support poles 701a-b from falling debris coming off of the buildings that may otherwise strike pedestrians as they enter, exit, and pass by the buildings 711-712.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

1. An earthquake safety protection device within a habitable space having a ceiling and a floor, the earthquake safety protection device comprises:
an earthquake support pole having a top end positioned about the habitable ceiling of a space and a bottom end;
a plurality of support members coupled to the top end of the earthquake support poles, the plurality of support members being perpendicular to the earthquake support pole and being adjacent to the ceiling; and
an anchoring mechanism coupling the bottom end of the earthquake support pole to the floor, the anchoring mechanism includes an in-ground anchor coupled to the one or more earthquake support poles, the in-ground anchor comprises a plurality of anchor arms radiating out from a center location;
wherein each of the plurality of anchor arms include a plurality of energy absorbing cross-members, all of which are within a central layer.

2. The earthquake safety protection device according to claim 1, wherein the plurality of support members each have a pair of ends and a center point; and
the plurality of support members are coupled to the earthquake support pole about the center point.

3. The earthquake safety protection device according to claim 1, wherein the plurality of support members each have a pair of ends and a center point; and
the plurality of support members are coupled to the earthquake support pole about the one of the ends of each support member.

4. The earthquake safety protection device according to claim 3, wherein the earthquake support pole is positioned within a corner of the habitable space.

5. The earthquake safety protection device according to claim 4, wherein the earthquake support pole further comprises a handle.

6. The earthquake safety protection device according to claim 2, wherein the earthquake support pole is positioned about a center of the habitable space.

7. The earthquake safety protection device according to claim 6, wherein the earthquake support pole is further coupled to a steel table having legs in contact with the floor of the habitable space.

8. The earthquake safety protection device according to claim 4, wherein the earthquake support pole further energy absorbing material between the earthquake support pole and the building foundation and anchoring material.

9. The earthquake safety protection device according to claim 4, wherein the energy absorbing material comprises a compressible material configured to dissipate the energy of the movement of the earthquake support pole relative to the building foundation and anchoring material.

10. The earthquake safety protection device according to claim 8, wherein the earthquake support pole further energy absorbing material between the earthquake support pole and the building foundation and anchoring material and between the earthquake support pole and the corner of the building in which the earthquake support pole is installed.

11. The earthquake safety protection device according to claim 8, wherein the multiple earthquake support poles are positioned at different locations within the building.

12. The earthquake safety protection device according to claim 11, wherein the multiple earthquake support poles are located on a plurality of floors of the building.

13. The earthquake safety protection device according to claim 12, wherein the multiple earthquake support poles on upper floors of the building are anchored into structural elements within the building.

14. The earthquake safety protection device according to claim 13, wherein the structural elements comprise steel beams within the building.

15. The earthquake safety protection device vice according to claim 12, wherein the one or more earthquake support poles being located outside of buildings about outside walls.
